(19) United States
(12) Patent Application Publication
(10) Pub. No.: US 2001/0027520 A1
(43) Pub. Date: Oct. 4, 2001

(54) Authentication substitution system and Authentication substitution method

(76) Inventor: Shigeo Mori, Tokyo (JP)

Correspondence Address: McGuire Woods, Suite 1800, 1750 Tysons Boulevard, Tysons Corner, McLean, VA, 22102, US

(21) Appl. No.: 09/814,784

(22) Filed: Mar. 23, 2001

(30) Foreign Application Priority Data
Mar. 27, 2000 (JP) 086664/2000

(51) Int. Cl. H04L 9/32; G06F 17/60

(52) U.S. Cl. 713/186; 705/44

(57) ABSTRACT

A vender terminal, when an order of an article is received through a communication network from a user terminal, issues an authentication request through the communication network to an authentication center terminal. The authentication center terminal carries out an authentication process in response to the authentication request from the vender terminal, and reports an authentication result to the vender terminal. The vender terminal reports an allowance or rejection of the order of the article to the user terminal, on the basis of this authentication result. The above-mentioned configuration enables the improvement of a safety in an electronic commerce and sureness in an authentication procedure. Moreover, it is possible to simplify a procedure for registering an authentication information and make a management of an authentication information effective.

### BACKGROUND OF THE INVENTION

1. Field of the Invention

The present invention relates to an authentication substitution system and an authentication substitution method for carrying out an authentication of, for example, a purchaser. More particularly, the present invention relates to a technique for unitarily carrying out an authentication of a purchaser by using living body authentication information when a sale contract of an article is established through a communication network such as the Internet.

2. Description of the Related Art

An electronic commerce has been widely carried out for ordering an article by accessing a server of an on-line vender who advertises and sells an article (including an article to be distributed such as a book and the like, an article to be distributed by using a network such as a music and the like) through a communication network such as the Internet.

An authentication of a user when the electronic commerce is carried out between the user (orderer) and the on-line vender is done as follows. That is, the on-line vender, when receiving the order of the article, urges the orderer to enter authentication information, such as a credit card number and the like, and then inquires of a credit card company the entered credit card number by an on-line.

However, in the electronic commerce using the communication network, there may be a case that transmission information is passed through many middle computer systems until its arrival at a transmission destination. So, there may be a fear that the transmission information is stolen on its way to the destination. Also, although the transmission information is typically encrypted, there may be a possibility that the transmission information is decrypted. Thus, it may be also a fear of a leak of the credit card number. Moreover, there may be a fear that a malicious orderer obtaining the leaked transmission information uses the stolen credit card number. As mentioned above, the conventional authentication method has a problem with regard to a security.

Also, in the conventional authentication method, a plurality of on-line venders, who respectively sell various articles, manage the authentication information, independently. So, a user must individually carry out a registration procedure for an authentication process for each on-line vender. Thus, each on-line vender must manage the authentication information in which a high security is required. This results in a problem that a burden for a safety attainment becomes severe. Also, the user must carry out the registration procedure for the authentication in a duplicate manner. Hence, this results in a problem that a complex procedure needs to be done several times.

### SUMMARY OF THE INVENTION

The present invention is accomplished in view of the above-mentioned problems. Therefore, an object of the present invention is to improve a safety in an electronic commerce and improve sureness in an authentication procedure and also simplify a procedure for registering authentication information and make an authentication information management effective.

In order to achieve the above-mentioned object, an authentication substitution system according to a first aspect of the present invention includes one or more user terminals, one or more vender terminals and an authentication center terminal. The user terminals are used to order articles. The vender terminals are used to receive order requests from the user terminals through a network. The authentication center terminal is used to carry out an authentication process in accordance with an authentication request entered through the network from each of the vender terminals and reporting an authentication result to the vender terminal.

The above-mentioned configuration enables the authentication center terminal to unitarily manage authentication information. So, this does not require a management of the authentication information on each vender terminal. Thus, the management of the authentication information can be made effective. Also, this does not require a registration of the authentication information to each of the vender terminals. Hence, it is possible to simplify a procedure for registering the authentication information.

Specifically, the authentication substitution system according to this first aspect of the present invention may be designed as follows. That is, the user terminal registers the authentication information composed of user identification information such as an ID number given to a user and the user authentication information in advance in the authentication center terminal. The vender terminal sends the user authentication information and the user identification information entered through the network from the user terminal to the authentication center terminal. The authentication center terminal collates the registered user identification information with the user identification information entered from the vender terminal to specify the registered user, and then collates the registered user authentication information corresponding to the specified user with the user authentication information entered from the vender terminal to thereby carry out the authentication process.

The above-mentioned configuration enables the authentication center terminal to substitute the authentication process based on the user identification information and the user authentication information. Also, this can remove the management burden of the user authentication information and the user identification information on each vender terminal and the burden of the authentication process. Thus, the management of the authentication information can be made effective. Also, this does not require the registration of the user identification information and the user authentication information to each of the vender terminals. Hence, it is possible to simplify the procedure for registering the authentication information.

The user authentication information can be living body authentication information determined on the basis of a physical characteristic of a user. This configuration enables a high security to be attained in an authentication of an electronic commerce by using a living body authentication technique (biometrics technique). Thus, it is possible to improve a safety in the electronic commerce and sureness in the authentication process.

In this case, the living body authentication information can be selected from at least one of information with regard to a fingerprint of the user, information with regard to a retina pattern of the user and information with regard to a voice of the user. This configuration enables the high security to be attained in the authentication of the electronic commerce by using the fingerprint authentication technique, the retina pattern authentication technique or the voiceprint authentication technique. Thus, it is possible to improve the safety in the electronic commerce and the sureness in the authentication process.

Also, the authentication substitution system according to this first aspect of the present invention may be designed as follows. That is, the vender terminal receives the order through voice information entered from the user terminal. The authentication center terminal responses to a voice recognition request from the vender terminal, and collates the voice information entered from the vender terminal with registered voice recognition information, and then carries out a voice recognition process.

This configuration can remove the necessity that each of the vender terminals has the voice recognition information. So, this can remove the management burden of the voice recognition information on each vender terminal. Also, each vender terminal need not prepare a large capacity of a memory in order to manage the voice recognition information. Thus, the management of the voice recognition information can be made effective. Also, this does not require the registration of the voice recognition information to each vender terminal. Hence, it is possible to largely simplify the procedure for registering the voice recognition information.

Also, the authentication center terminal can be designed such that voice recognition fee information based on the voice recognition process is reported to the vender terminal, after a completion of a procedure between the user terminal and the vender terminal. This configuration enables information of a fee with regard to a substitution of an authentication, for example, such as a claim of a voice recognition substitution fee and the like, to be reported to the vender terminal. Thus, it is possible to quickly send and receive the voice recognition fee information.

Moreover, the authentication center terminal can be designed such that the authentication fee information based on the authentication substitution is reported to the vender terminal, after a completion of the procedure between the user terminal and the vender terminal. This configuration enables information of a fee with regard to a substitution of an authentication, for example, such as a claim of an authentication substitution fee and the like, to be reported to the vender terminal. Thus, it is possible to quickly send and receive the authentication fee information.

An authentication substitution method according to a second aspect of the present invention comprises the steps of receiving authentication information sent based on an order request of an article from a user, carrying out an authentication request based on the order request, carrying out an authentication process in response to the authentication request, reporting an authentication result and allowing a reception of the order based on an authentication result.

The above-mentioned configuration enables the authentication information to be unitarily managed, and this can remove the necessity that the authentication information in which the high safety is required is kept in a plurality of portions. Thus, the management of the authentication information can be made effective. Moreover, it is possible to reduce the burden of the registration of the authentication information, and thereby possible to simplify the procedure for registering the authentication information.

An authentication substitution method according to a third aspect of the present invention comprises the steps of receiving authentication information sent based on an order request of an article from a user, issuing an authentication request based on the order request and allowing a reception of the order based on an authentication result reported in response to the authentication request.

The above-mentioned configuration enables the request of the authentication to judge whether or not the reception is allowed for the order request. So, this can remove the necessity of saving the authentication information in which the high safety is required. Thus, the management burden of the authentication information can be removed to thereby make the management of the authentication information effective. Moreover, it is possible to remove the burden of the registration of the authentication information, and thereby possible to simplify the procedure for registering the authentication information.

Also, it can be designed so as to send user identification information and user authentication information as the authentication information to then issue the authentication request. This configuration enables the request of the authentication process based on the user identification information and the user authentication information. So, the management burdens of the user identification information and the user authentication information and the burden of the authentication process can be removed to thereby make the management of the authentication information effective. Moreover, it is possible to reduce the registration burdens of the user identification information and the user authentication information, and thereby possible to simplify the procedure for registering the authentication information.

An authentication substitution method according to a fourth aspect of the present invention comprises the steps of carrying out an authentication process in response to an authentication request based on an order request of an article involving a transmission of authentication information from a user and reporting an authentication result.

The above-mentioned configuration enables the substitution of the authentication to judge whether or not a reception is allowed for the order request. Also, it is possible to collectively possess the authentication information in which the high safety is required. So, this can remove the management burden of the authentication information. Thus, the management of the authentication information can be made effective. Also, it is possible to collectively receive the registrations of the authentication information, and thereby possible to simplify the procedure for registering the authentication information.

The fourth aspects of the present invention can be designed to comprise the steps of receiving an authentication request with the authentication information including entered user identification information and user authentication information, collating registered user identification information with the entered user identification information to accordingly specify the user and collating the registered user authentication information corresponding to the specified user with the entered user authentication information.

The above-mentioned configuration enables the substitution of the authentication process based on the user identification information and the user authentication information. The user identification information and the user authentication information can be collectively managed to thereby make the management of the authentication information effective. Also, because it is enough to collectively register the user identification information and the user authentication information, it is possible to simplify the procedure for registering the authentication information.

In this case, living body authentication information determined on the basis of a physical characteristic of a user can be used as the user authentication information. This configuration enables a high security to be attained in an authentication of an electronic commerce by using a living body authentication technique. Thus, it is possible to improve the safety in the electronic commerce and sureness in the authentication process.

Also, this can be designed so as to receive the order of the article through voice information, issue a voice recognition request in response to the order, and determine order reception information based on the voice recognition result reported in response to the voice recognition request.

The above-mentioned configuration can remove the necessity of saving voice recognition information and also remove a management burden of the voice recognition information. Also, because it is not necessary to prepare a large capacity of a memory in order to manage the voice recognition information composed of a large amount of data as the authentication information, the management of the voice recognition information can be made effective. Also, this configuration does not require the registration of the voice recognition information. The registration of the voice recognition information needs a considerable burden but it is possible to largely simplify the procedure for registering the voice recognition information.

Alternatively, this can be designed so as to receive the voice recognition request based on the order of the article through the voice information, and collate the voice information at the time of the order with registered voice recognition information, and carry out a voice recognition process, and then report the voice recognition result.

The above-mentioned configuration enables the voice recognition information to be collectively possessed, and thereby enables the management burden of the voice recognition information to be concentrated on one position. Also, because it is enough to collectively prepare the large capacity of the memory in order to manage the voice recognition information especially needing the large amount of data as the authentication information, the management of the voice recognition information can be made effective. Also, the voice recognition information can be collectively registered. The registration of the voice recognition information needs the considerable burden but it is possible to largely simplify the procedure for registering the voice recognition information.

Also, this can be designed so as to report voice recognition fee information based on the voice recognition process after a completion of an order procedure. This configuration enables a quick report of information of a fee with regard to a substitution of an authentication, for example, such as a claim of a voice recognition substitution fee and the like. Thus, it is possible to quickly send and receive the voice recognition fee information.

Moreover, this can be designed so as to report authentication fee information based on a recognition substitution after the completion of the order procedure. This configuration enables a quick report of the information with regard to the fee with regard to the substitution of the authentication, such as the claim of the authentication substitution fee and the like. Thus, it is possible to quickly send and receive the authentication fee information.

### BRIEF DESCRIPTION OF THE DRAWINGS

FIG. 1 is a block diagram showing an example of a configuration of an authentication substitution system according to a first embodiment of the present invention;

FIG. 2 is an explanation view showing an example of execution timing and contents of processes for registering authentication information, in the authentication substitution system according to the first embodiment of the present invention;

FIG. 3 is an explanation view showing an example of a stored state in an authentication information store area used in the authentication substitution system according to the first embodiment of the present invention;

FIG. 4 is an explanation view showing an example of execution timing and contents of an electronic commerce process including an authentication process in the authentication substitution system according to the first embodiment of the present invention;

FIG. 5 is an explanation view showing an example of execution timing and contents of an electronic commerce process including a voice recognition process in the authentication substitution system according to a second embodiment of the present invention;

FIG. 6 is an explanation view showing an example of a stored state in a user information store area according to the second embodiment of the present invention; and

FIG. 7 is an explanation view showing another example of the stored state in the authentication information store area used in the authentication substitution system according to the first embodiment of the present invention.

### DESCRIPTION OF THE PREFERRED EMBODIMENTS

Now, embodiments of the present invention will be described below with reference to the attached drawings.

### First Embodiment

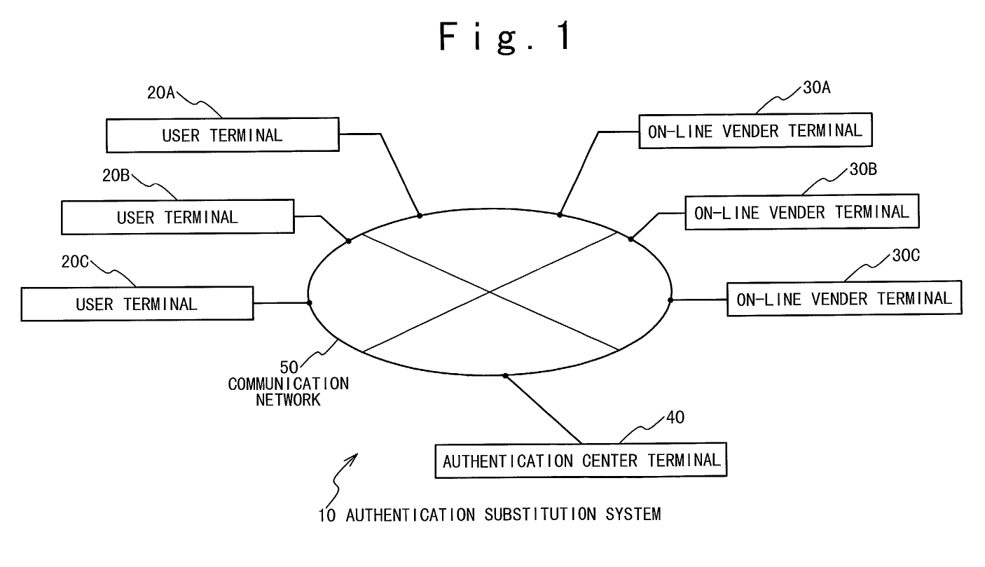

FIG. 1 is a block diagram showing an example of a configuration of an authentication substitution system 10 according to a first embodiment of the present invention. The authentication substitution system 10 is composed of user terminals 20A to 20C, on-line vender terminals 30A to 30C and an authentication center terminal 40. The user terminals 20A to 20C, the on-line vender terminals 30A to 30C and the authentication center terminal 40 are connected to each other through a communication network 50 such as the Internet. It should be noted that the numbers of user terminals and on-line vender terminals that are connected to the communication network 50 are three, respectively, but any numbers of them may be connected to it. Also, a plurality of authentication center terminals 40 may be prepared for each territory, or, for each field of the on-line venders.

Each of the user terminals 20A to 20C is composed of an information processor, such as a personal computer and the like, and an information communication apparatus, such as a telephone and the like. Each of the user terminals 20A to 20C has a function of ordering an article to be purchased to the on-line vender terminals 30A to 30C according to an operation of each user. In this authentication substitution system 10, each of the user terminals 20A to 20C has a function of reading living body information of a user, such as fingerprint information, voiceprint information and retina pattern information, and converting it into data having a predetermined format and has a function of sending the converted data of the living body information to the on-line vender terminals 30A to 30C and the authentication center terminal 40. It should be noted that the conversion of the living body information into the data having the predetermined format may be executed by employing an external apparatus.

The respective user terminals 20A to 20C are used by a person who sells an article through the communication network 50, and they are constituted by the information processors such as workstation servers and the like. Each of the on-line vender terminals 30A to 30C has a function of providing information with regard to an article, which is advertised and sold by the on-line vender, through the communication network 50 to the user terminals 20A to 20C and has a function of receiving the orders from the user terminals 20A to 20C.

Also, each of the on-line vender terminals 30A to 30C has a function of transferring authentication information received from the user terminals 20A to 20C to the authentication center terminal 40 and determining allowance or rejection of a reception of an order in accordance with an authentication result of the authentication center terminal 40. The authentication information is composed of living body authentication information as authentication information and user identification information. The user identification information is composed of a name of a user, a date of the user's birth and the like to identify the user. Also, the living body authentication information is composed of data indicative of a physical characteristic of the user.

The authentication center terminal 40 is the terminal apparatus used by an authentication center for receiving a request from each on-line vender and substituting an authentication. The authentication center terminal 40 is composed of information processors such as workstation servers and the like. The authentication center terminal 40 has a function of managing the authentication information of many users, a function of carrying out an authentication process of a user specified in response to an authentication request from each of the on-line vender terminals 30A to 30C, and a function of adding up the fees caused by the executions of the authentication processes and charging to each of the on-line vender terminals 30A to 30C.

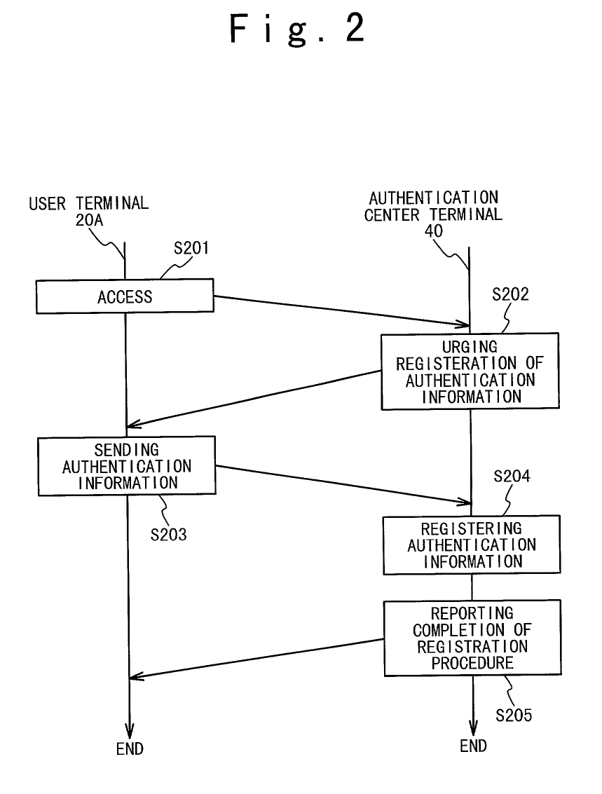

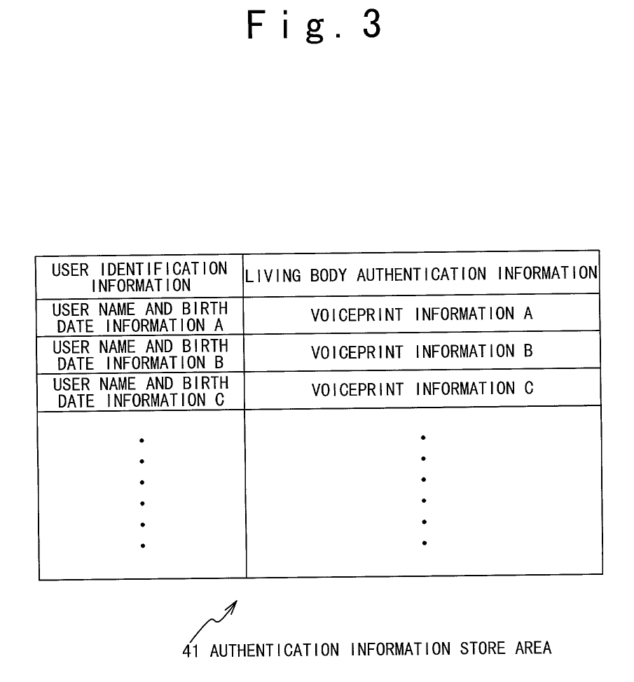

A process for registering authentication information, in the authentication substitution system 10 according to the first embodiment of the present invention, will be described below with reference to FIGS. 2 and 3. Here, the process for registering the authentication information by using the user terminal 20A operated by a user is described.

As shown in FIG. 2, a user firstly operates the user terminal 20A to access the authentication center terminal 40 (Step S201). When the user terminal 20A is connected through the communication network 50 to the authentication center terminal 40, the authentication center terminal 40 urges the user terminal 20A to register authentication information (Step S202). That is, a transmission request of the authentication information is sent to the user terminal 20A.

The user, who is urged to register the authentication information, enters living body authentication information to the user terminal 20A by using a living body information input device such as a fingerprint reader, a voiceprint reader and a retina pattern reader. Then, the user terminal 20A sends the authentication information including the user identification information and the living body authentication information to the authentication center terminal 40, in response to the transmission request from the authentication center terminal 40 (Step S203).

The authentication center terminal 40, when receiving the authentication information, registers the authentication information in a later-described authentication information store area 41 (refer to FIG. 3) (Step S204). The authentication information store area 41 is positioned within the authentication center terminal 40, and it is constituted by a large capacity of a memory. The authentication information is registered under such a condition that the user identification information and the living body authentication information are correlated to each other, as shown in FIG. 3.

When the authentication information is registered in the authentication information store area 41, the authentication center terminal 40 reports a completion of the registration procedure to the user terminal 20A (Step S205). When the completion of the registration procedure is reported, the process for registering the authentication information is ended. In this way, the user registers the authentication information in the authentication center terminal 40 in advance of the execution of an electronic commerce of an article.

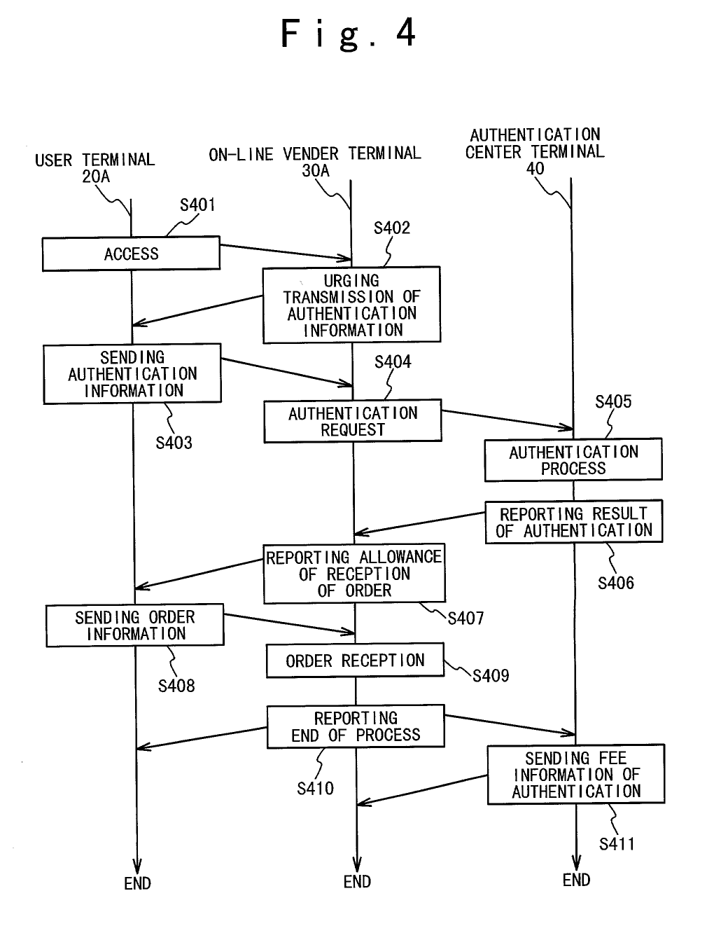

The electronic commerce process including the authentication process in the authentication substitution system 10 according to the first embodiment of the present invention will be described below with reference to FIG. 4. FIG. 4 is an explanation view showing an example of execution timing and contents in the electronic commerce process including the authentication process in this authentication substitution system 10. Here, such a process is described that an article provided by the on-line vender terminal 30A is ordered by using the user terminal 20A.

At first, a user (orderer) operates the user terminal 20A to access the on-line vender terminal 30A (Step S401). When the user terminal 20A is connected through the communication network 50 to the on-line vender terminal 30A, the on-line vender terminal 30A urges the user terminal 20A to transmit authentication information (Step S402).

When the transmission of the authentication information is urged, the user terminal 20A sends the living body authentication information entered by the user with the living body information input device together with the user identification information as the authentication information to the on-line vender terminal 30A (Step S403).

The on-line vender terminal 30A, when receiving the authentication information from the user terminal 20A, issues an authentication request by sending the authentication information to the authentication center terminal 40 (Step S404).

The authentication center terminal 40, when receiving the authentication request, carries out the authentication process (Step S405). That is, the authentication center terminal 40 retrieves the authentication information store area 41, and searches for user identification information (for example, a user name and birth date information A shown in FIG. 3) corresponding to the received user identification information, and extracts living body authentication information (for example, voiceprint information A shown in FIG. 3) correlated to the searched user identification information. Then, the authentication center terminal 40 judges whether or not the extracted living body authentication information coincides with the received living body authentication information. In this judgment, even if they are not perfectly equal to each other, it may be judged that they are equal to each other when the difference is within a predetermined error range.

If the extracted living body authentication information and the received living body authentication information are equal to each other, it is so judged that the user who is accessing by using the user terminal 20A is identical to the registered person. Thereby, an user's identity is authenticated, and its result is reported to the on-line vender terminal 30A (Step S406). On the other hand, if the extracted living body authentication information is different from the received living body authentication information, it is so judged that the user who is accessing by using the user terminal 20A is different from the registered person. Thereby, the user's identity is not authenticated, and its result is reported to the on-line vender terminal 30A (Step S406).

If the fact that the user's identity is authenticated is reported from the authentication center terminal 40 at the step S406, the on-line vender terminal 30A reports allowance of the reception of the order to the user terminal 20A. Then, the on-line vender terminal 30A urges the terminal 30A to order the article (Step S407). On the other hand, if the fact that the user's identity is not authenticated is reported from the authentication center terminal 40 at the step S406, the on-line vender terminal 30A reports to the user terminal 20A such a fact that the order can not be received.

If the reception of the order is allowed, the user terminal 20A sends to the on-line vender terminal 30A order information (including an article name, the number of articles and the like) with regard to the order article and the like selected by the operation of the user (Step S408).

The on-line vender terminal 30A, when receiving the order information, carries out an order reception process for receiving or accepting the order from the user terminal 20A (Step S409). When the order reception process is ended, the on-line vender terminal 30A reports the end of the order reception process to the user terminal 20A and the authentication center terminal 40 (Step S410).

The authentication center terminal 40, when receiving the report of the end of the order reception process, calculates a fee with regard to the substitution of the authentication, and then sends information with regard to the fee (fee information) to the user terminal 20A (Step S409). The fee information includes, for example, information with regard to a fee to be charged or information with regard to a fee to be settled (in a case in which an on-line vender pays an expected authentication substitution fee in advance to an authentication center) and the like.

After the fee information is sent and received, the electronic commerce process in the authentication substitution system 10 is completed.

As mentioned above, according to the authentication substitution system according to this first embodiment of the present invention, the authentication center receiving the request from each on-line vender who requires the authentication when the electronic commerce is carried out substitutes the authentication procedure, and the authentication center unitarily manages the authentication information. As a result, it is not necessary that the authentication information in which the high safety is required is possessed by each of the on-line venders. Also, it is possible to remove the management burden of the authentication information on each on-line vender. Also, even if the living body authentication information requiring a large amount of data as the authentication information is used for the authentication, each on-line vender are not required to prepare a large capacity of a memory. Thus, it is possible to make the management of the authentication information effective and also possible to reduce the cost burden.

Also, the above-mentioned configuration does not require the registration of the authentication information to each on-line vender. That is, the user can carry out the electronic commerce with various on-line venders only by collectively registering the authentication information in the authentication center (only by one registration in a case of one authentication center). Especially, it generally takes a long time to register the living body authentication information. Thus, it is possible to simplify the procedure for registering the authentication information by the above-mentioned configuration.

As mentioned above, it is designed to use the living body authentication information as the authentication information. Thus, the high security using the living body authentication technique can be attained in the electronic commerce including the authentication procedure. Hence, it is possible to improve the safety in the electronic commerce and improve the sureness in the authentication procedure. In recent years, as a device for authenticating a person safely and surely, an authentication device using living body authentication information has been used in many cases. A cheaper price of an apparatus used in the living body authentication technique is put forward, for example, such as the fingerprint reader, the voiceprint reader and the retina pattern reader. Accordingly, the living body authentication technique can be introduced at a low cost, and the high safety can be attained at the cheap price.

As mentioned above, it is designed that the authentication center terminal 40 calculates the fee with regard to the substitution of the authentication and sends the authentication fee information to the on-line vender terminal 30A. Thus, the information of the fee with regard to the substitution of the authentication, such as the charge of the authentication substitution fee and the like, can be reported to the on-line vender terminal 30A. Hence, it is possible to quickly send and receive the authentication fee information.

### Second Embodiment

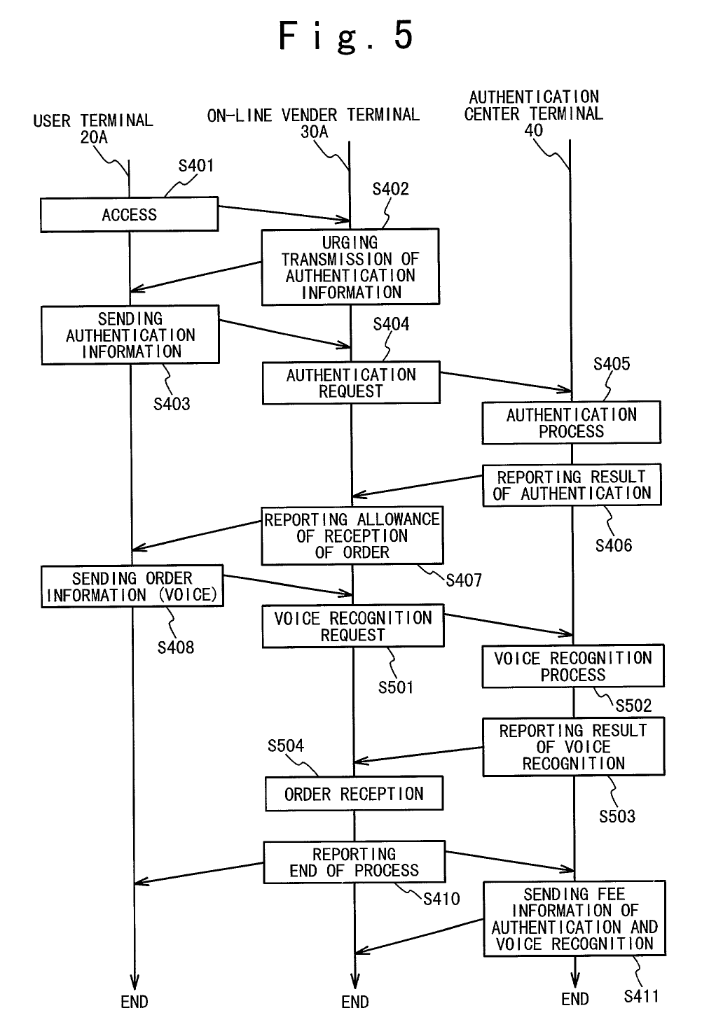

The above-mentioned authentication substitution system according to the first embodiment of the present invention is designed such that the authentication process of the one's identity is carried out prior to the execution of the actual order procedure (for example, a procedure for selecting a purchase article and a procedure for requesting an order and the like). An authentication substitution system according to this second embodiment of the present invention further checks one's identity at the time of the actual order procedure, in addition to the above-mentioned authentication process. The check procedure can be performed in such a case that the actual order procedure is carried out by using a living body medium such as a voice and the like. In this case, processes shown in FIG. 5 may be executed. It should be noted that, in FIG. 5, the same symbols are given to the members for carrying out the process equal to that shown in FIG. 4 and the detailed explanations are omitted.

FIG. 5 is an explanation view showing an example of execution timing and contents in an electronic commerce process including a voice recognition process in the authentication substitution system 10 according to the second embodiment of the present invention. Here, such a case is described that the article provided by the on-line vender terminal 30A is ordered from the user terminal 20A through a voice.

When the reception of the order is allowed after the authentication, the user terminal 20A sends to the on-line vender terminal 30A the order information generated based on the voice emitted by the user (Step S408). The order of the article through the voice is done such that the user speaks an article name, the number of articles and the like to a voice input device (for example, a microphone).

The on-line vender terminal 30A, when receiving the order information from the user terminal 20A, requests a voice recognition by transferring the received voice information to the authentication center terminal 40 (Step S501).

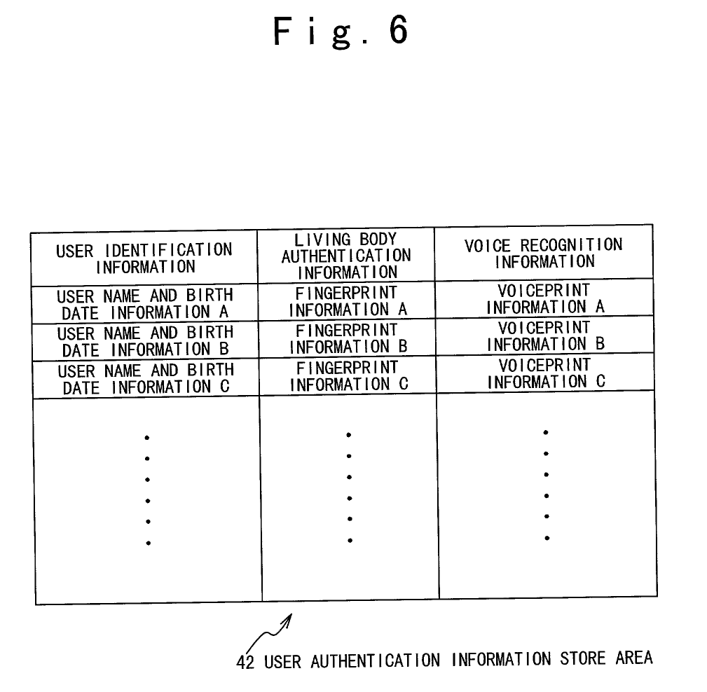

The authentication center terminal 40, when receiving the request of the voice recognition, carries out the voice recognition based on the stored voiceprint information correlated to the user identification information (Step S502). Then, the authentication center terminal 40 reports the order information including the article name and the number of articles recognized by the voice recognition process to the on-line vender terminal 30A (Step S503). If the authentication information is composed of the voice (voiceprint), the living body authentication information may be commonly used as the voice recognition information. If the authentication information is not composed of the voice, the living body authentication information and the voice recognition information may be correlated to the user identification information and stored in a user information store area 42, as shown in FIG. 6.

The on-line vender terminal 30A, when receiving the recognition result, carries out an order reception process for receiving the order based on the reception information from the authentication center terminal 40 (Step S504). When the order reception process is ended, the on-line vender terminal 30A reports the end of the order reception process to the user terminal 20A and the authentication center terminal 40 (Step S410).

The authentication center terminal 40, when receiving the report of the end of the order reception process, calculates a fee with regard to the substitution of the authentication and a fee with regard to the voice recognition, and sends an information with regard to those fees (fee information) (Step S411). The fee information includes, for example, information with regard to a fee to be charged, an information with regard to a fee to be settled (in a case in which the on-line vender pays an expected authentication substitution fee and voice recognition fee in advance to the authentication center) and the like.

After the fee information is sent and received, the electronic commerce in which the authentication process and the voice recognition process is included is completed in this authentication substitution system 10.

As mentioned above, in the authentication substitution system according to the second embodiment of the present invention, the authentication center receiving the request from each on-line vender who requires the voice recognition when the electronic commerce is carried out substitutes the voice recognition process, and the authentication center unitarily manages the voice recognition information. Accordingly, it is not necessary that the voice recognition information is possessed by each of the on-line venders. Also, it is possible to remove the management burden of the voice recognition information on each on-line vender. Also, each on-line vender are not required to prepare a large capacity of a memory for managing the voice recognition information requiring a large amount of data as the authentication information. Hence, it is possible to make the management of the voice recognition information effective.

Also, the above-mentioned configuration does not require the registration of the voice recognition information to each on-line vender. That is, the user can carry out the electronic commerce with the various on-line venders only by collectively registering the voice recognition information in the authentication center (only by one registration in a case of one authentication center). The registration of the voice recognition information is carried out by registering the emitted tones (for example, 50 tones). So, it imposes a considerable burden on the user trying the registration. However, according to this authentication substitution system, it is possible to largely simplify the procedure for registering the voice recognition information (even in a case of using the voiceprint as the authentication information, it is similarly possible to largely simplify the procedure for registering the authentication information).

In the above-mentioned authentication substitution system according to the second embodiment of the present invention, when the voice information is also used as the authentication information, the voice information can be used as the authentication information and the voice recognition information. Thus, it is possible to make the management of the voice recognition information further effective and also possible to further largely simplify the procedure for registering the voice recognition information.

Moreover, the authentication substitution system according to the second embodiment of the present invention is designed such that the authentication center terminal 40 calculates the fee with regard to the substitution of the voice recognition process and sends the voice recognition fee information to the on-line vender terminal 30A. Thus, the information of the fee with regard to the substitution of the voice recognition, such as the charge of the voice recognition substitution fee and the like, can be reported to the on-line vender terminal 30A. Hence, it is possible to quickly send and receive the voice recognition fee information.

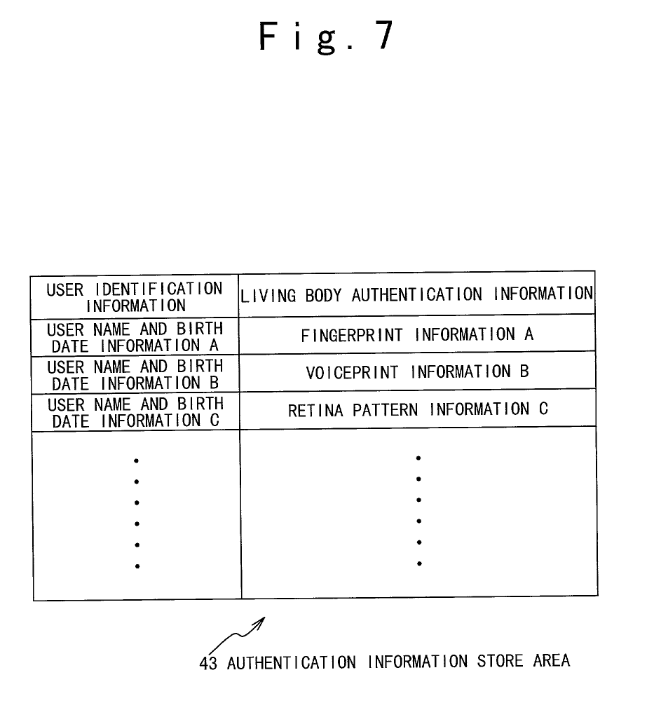

Also, in the authentication substitution system according to the first embodiment of the present invention, the living body authentication information registered in the authentication information store area 41 is assumed to be the living body information equal to those in the respective users. However, it may be a living body information different for each user. In this case, the living body information may be defined for each user and stored in an authentication information store area 43 as shown in FIG. 7.

As described in detail above, according to the present invention, the authentication center terminal can unitarily manage the authentication information. Each of a plurality of vender terminals is not required to possess the authentication information in which the high safety is required. So, this does not require the management burden of the authentication information on each vender terminal. Thus, the management of the authentication information can be made effective. Also, this does not require the registration of the authentication information to each of the vender terminals. That is, the user can carry out the electronic commerce with each vender terminal only by collectively registering the authentication information in the authentication center terminal. Hence, it is possible to simplify the procedure for registering the authentication information.

The authentication center terminal can substitute the authentication process, in accordance with the user identification information and the user authentication information. So, it is possible to remove the management burdens of the user identification information and the user authentication information on each vender terminal, and the authentication process burden. Thus, the management of the authentication information can be made effective. Moreover, it is possible to disuse the registration of the user identification information and the user authentication information on each vender terminal. Hence, it is possible to simplify the procedure for registering the authentication information.

What is claimed is:

1. An authentication substitution system comprising:
a user terminal;
a vender terminal;
an authentication center terminal; and
a communication network through which said user terminal, said vender terminal and said authentication center terminal are connected,
wherein said user terminal includes:
an order request portion which issues an order request by sending authentication information for authenticating one's identity to said vender terminal; and
an order information sending portion which sends order information for ordering an article to said vender terminal in response to allowance of the order request reported from said vender terminal,
said vender terminal includes:
an authentication request portion which issues an authentication request by sending the authentication information from said user terminal to said authentication center terminal;
an order reception allowance reporting portion which judges allowance or rejection of the order request from said user terminal based on an authentication result from said authentication center terminal and reports to said user terminal; and
an order receiving portion which accepts the order request when the order information from said user terminal is received, and
said authentication center terminal includes:
an authentication processing portion which carries out an authentication process to authenticate the one's identity based on the authentication information received from said vender terminal; and
an authentication result reporting portion which sends the authentication result obtained from said authentication processing portion to said vender terminal.

2. The authentication substitution system according to claim 1, wherein said authentication center terminal includes
an authentication information store area for registering the authentication information sent from said user terminal, and composed of user identification information to specify a user and user authentication information to authenticate the user, and
said authentication processing portion collates the user identification information registered in said authentication information store area with the user identification information sent from said vender terminal to specify the user, and collates the user authentication information registered in said authentication information store area, corresponding to the specified user, with the user authentication information sent from said vender terminal to carry out the authentication process.

3. The authentication substitution system according to claim 2, wherein the user authentication information is living body authentication information including a physical characteristic of a user.

4. The authentication substitution system according to claim 3, wherein the living body authentication information is composed of at least one of a fingerprint of the user, a retina pattern of the user and a voice of the user.

5. The authentication substitution system according to claim 4, wherein said authentication center terminal further includes:
an authentication fee information sending portion which reports authentication fee information including an authentication fee caused by the authentication processes to said vender terminal, after a procedure between said user terminal and said vender terminal is completed.

6. The authentication substitution system according to claim 5, wherein
said order information sending portion of said user terminal sends voice information in which the order information is constituted by a voice to said vender terminal,
said vender terminal further includes:
a voice recognition request portion which issues a voice recognition request by sending the voice information from said user terminal to said authentication center terminal, wherein said order receiving portion accepts the order request from the user terminal based on a voice recognition result from authentication center terminal, and
said authentication center terminal further includes:
a voice recognition processing portion which carries out a voice recognition process based on the voice information received from said vender terminal; and
a voice recognition result reporting portion which sends the voice recognition result obtained by said voice recognition processing portion to said vender terminal.

7. The authentication substitution system according to claim 6, wherein
said authentication information store area of said authentication center terminal further stores voice information sent from said user terminal as voice recognition information, and
said voice recognition processing portion collates the user identification information registered in said authentication information store area with the user identification information sent from said vender terminal to specify the user, and collates the voice recognition information registered in said authentication information store area, corresponding to the specified user, with the voice information sent from said vender terminal to carry out the voice recognition process.

8. The authentication substitution system according to claim 7, wherein the authentication fee information further includes a recognition fee caused by the voice recognition process.

9. An authentication substitution method comprising:
providing
a user terminal;
a vender terminal
an authentication center terminal; and
a communication network through which said user terminal, said vender terminal and said authentication center terminal are connected;
carrying out, in said user terminal, an order request by sending authentication information for authenticating one's identity to said vender terminal;
carrying out, in said vender terminal, an authentication request by sending the authentication information from said user terminal to said authentication center terminal;
carrying out, in said authentication center terminal, an authentication process to authenticate the one's identity based on the authentication information received from said vender terminal;
sending, in said authentication center terminal, an authentication result obtained by the authentication process to said vender terminal;
judging, in said vender terminal, allowance or rejection of the order request from said user terminal based on the authentication result from said authentication center terminal and reports to said user terminal;
sending, in said user terminal, order information for ordering an article to said vender terminal in response to allowance of the order request reported from said vender terminal; and
accepting, in said vender terminal, the order request when the order information from said user terminal is received.

10. The authentication substitution method according to claim 9; wherein
registering, in said authentication center terminal, the authentication information sent from said user terminal in an authentication information store area, the authentication information being composed of user identification information to specify a user and user authentication information to authenticate the user, and
collating, in said authentication center terminal, the user identification information registered in said authentication information store area with the user identification information sent from said vender terminal to specify the user, and collating the user authentication information registered in said authentication information store area, corresponding to the specified user, with the user authentication information sent from said vender terminal to carry out the authentication process.

11. The authentication substitution method according to claim 10, wherein the user authentication information is living body authentication information including a physical characteristic of a user.

12. The authentication substitution method according to claim 11, wherein the living body authentication information is composed of to at least one of a fingerprint of the user, a retina pattern of the user and a voice of the user.

13. The authentication substitution method according to claim 12, wherein further comprising:
reporting, in said authentication center terminal, authentication fee information including an authentication fee caused by the authentication processes to said vender terminal, after a procedure between said user terminal and said vender terminal is completed.

14. The authentication substitution method according to claim 13, further comprising:
sending, in said user terminal, voice information in which the order information is constituted by the voice to said vender terminal;
carrying out, in said vender terminal, a voice recognition request by sending the voice information from said user terminal to said authentication center terminal;
carrying out, in said authentication center terminal, a voice recognition process based on the voice information received from said vender terminal;
sending, in said authentication center terminal, the voice recognition result obtained by the voice recognition process to said vender terminal; and
accepting, in the vender terminal, the order request from the user terminal based on a voice recognition result from authentication center terminal.

15. The authentication substitution method according to claim 14, further comprising:
storing, in said authentication center terminal, voice information sent from said user terminal as voice recognition information into said authentication information store area, and
collating, in said authentication center terminal, the user identification information registered in said authentication information store area with the user identification information sent from said vender terminal to specify the user, and collating the voice recognition information registered in said authentication information store area, corresponding to the specified user, with the voice information sent from said vender terminal to carry out a voice recognition process.

16. The authentication substitution method according to claim 15, wherein the authentication fee information further includes a recognition fee caused by the voice recognition process.
